(19) United States
(12) Patent Application Publication
(10) Pub. No.: US 2007/0046565 A1
(43) Pub. Date: Mar. 1, 2007

(54) Electronic image display system

(76) Inventor: Daniel Langlois, Montreal (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 11/531,323

(22) Filed: Sep. 13, 2006

Related U.S. Application Data
(63) Continuation-in-part of application No. 10/389,614, filed on Mar. 17, 2003, now Pat. No. 7,133,002.

(30) Foreign Application Priority Data
Mar. 15, 2006 (CA) 2,376,896

(51) Int. Cl. G09G 5/00

(52) U.S. Cl. 345/8

(57) ABSTRACT

The present invention relates to an electronic image display system. The system of the invention can be used, for example, as an advertising device using audiovisual presentations of digital image files, digital video files, and/or digital audio files.

### CROSS-REFERENCE TO RELATED APPLICATIONS

This application is a continuation in part of commonly assigned U.S. patent application Ser. No. 10/389,614, filed on Mar. 17, 2003 and entitled “Portable Display System”. The content of the aforesaid application is fully incorporated herein by reference to the extent not inconsistent with the disclosure presented hereinbelow.

### FIELD OF THE INVENTION

The present invention generally relates to display system and more particularly to electronic image display systems.

### BACKGROUND OF THE INVENTION

Various methods for advertising exist today in abundance. Many of the more common methods of advertising include billboards and signs, which are posted in locations frequented by many people. These methods of advertising while useful have a significant drawback in that they require large amounts of space. There is therefore a limited amount of signs and billboards which can be placed in an area before the area becomes saturated. Furthermore, signs and billboards often require significant effort to change advertising should one desire replace an old advertisement with a new advertisement.

Other less frequent methods of advertising include wearable signs which are carried by a human operator in a populated area. This method solves some of the problems of space which are involved with normal signs and billboards, though the wearable signs can often lack aesthetics qualities and be quite uncomfortable for the wearer. Additionally the wearable signs are still static and need to be replaced if a new advertisement is desired.

Recently as technology has progressed, and miniaturisation techniques have been improved, several types of portable electronic devices have been made available. These sorts of devices include a range of devices from portable telephones to personal computer which can be mounted on a person's body. Examples of these kinds of devices can be seen in for instance U.S. Pat. No. 6,140,981 to Kuenster et al, and U.S. Pat. No. 6,057,966 to Carroll et al.

There has also been an attempt at including video images on garments, see for example U.S. Pat. No. 5,912,653 to Stephan Fitch. This device while allowing changeable images on a person, are not useful for large scale advertising since the display is not visible above the people's heads in high traffic areas and the display has to be of reduced weight to prevent tearing of the garment.

As can be seen from the prior art there is a need for a portable dynamic display device which can be used for large scale advertising and audiovisual presentations.

### SUMMARY OF THE INVENTION

In a first aspect of the invention, there is provided an electronic image display system comprising a projector for displaying a video image. The display system comprises image input means and means to connect it to an electrical power source, a support structure having means to attach the support structure to a human body. The support structure further comprises a storage device for storing at least one video program including data for the video image, a video signal generating means to send the video image to the projector, and communication means between the projector and the video signal generating means. Hence, the support structure is adapted to carry the storage device supporting the video program to be displayed by the projector and sent thereto by the video signal generating means via the communication means.

In another aspect, the invention includes an out-of-home audiovisual presentation method comprising:
a) the use of a nomadic technology to provide the ability:
   i. to present audiovisual content at any location having a surface capable of receiving a projected image;
   ii. to target the time of the presentation;
   iii. to target the geographical area and the venues in which the content is presented;
b) a human being wearing audiovisual equipment providing the ability:
   i. to rapidly change the time or location of the presentation;
   ii. to interact with the audience verbally or with signs;
   iii. to distribute and hand out collateral materials directly to passer-by's;
c) the use of commercially available equipment to enable:
   i. reproduction of existing broadcast quality and multimedia content in the MPEG-2 encoding format or other encoding format known in the art;
   ii. playback from any DVD or other similar multimedia storage device that can be read with a commercial DVD player or other similar multimedia playing device;
   iii. playback from any software application that can run on a commercial portable computer;
   iv. display of any visual content fit for projector devices;
   v. projection of such visual content.

In another embodiment, the invention may be a wearable and nomadic technology comprising:
a) a costume customizable to each specific activity and facilitating the integration to a specific event or product brand, generally comprising a long trench coat or other costume element designed for hiding the backpack straps;
b) an electronic image display system with the following specifications:
   i. projector means;
   ii. very light weight;
   iii. native resolution: true XGA 1024×768 or better;
   iv. data compatibility: all standard modes, including VESA, VGA, SVGA, XGA, and/or SXGA 85 Hz;
   v. video compatibility: Full NTSC (M 4.43), PAL (BGHI, M, N), SECAM (M), HDTV (720p and 1080i RGBHV) and/or other known standards;
c) a backpack for the projector set-up preferably made of a hard plastic shell containing:
   i. a low voltage VDC audio amplifier, and two speakers located preferably on each side of the character's waist;
   ii. one ore more batteries as light as possible, and a DC to AC electrical converter;
   iii. a commercial type portable DVD or other media player or a portable computer, both requiring external audio and video output ports and their own battery pack.

The electronic image display system may be used with standard technology for wired data transmission or wireless data transmission. In the latter case, a wireless projector is used and both the wireless projector and the backpack are equipped with transceivers to transmit the video signal from the portable DVD or other media player or the portable computer to the projector. Understandably, a projector having both types of connections (i.e. wired and wireless) can be used to adapt to different signals, by cable means or wireless transmission.

According to another aspect of the invention, the projector may be fixed on a telescopic pole which may be held by the human operator at different heights and in different positions. It can also be fixed on a tripod to stand alone at different heights and in different positions, the human operator being near enough to provide the video signal. Still, the projector could also be mounted to a support member fixed to the backpack worn by the operator. In this latter case, depending of the shape of the support member and/or the intended use of the projector, the projector could be located beside the operator or above its shoulders or even its head. Understandably, by changing the shape of the support member, the projector could be located at other locations. Nevertheless, in all these configurations, the projector is preferably attached (to the telescopic pole, the tripod or the support member) so as to allow the human operator to modify the orientation of the projection. A pivotal connector, known in the art, could be used for that matter. Thus, the video image projected by the projector could be directed on any surfaces and even on the ground by changing the orientation of the projector. Finally, the projector may be removable from the telescopic pole or the tripod to be disposed on a surface or on the human operator with appropriate fastening means.

While the invention has been described in relation to several embodiments it will be apparent to those skilled in the art that several modifications and variations not mentioned exists. Accordingly the previous descriptions are only meant for the purposes of illustration, and are not meant to limit the scope of the invention.

### BRIEF DESCRIPTION OF THE DRAWINGS

A preferred embodiment of the present invention will be described in greater detail below with reference to the following drawings, in which:

FIG. 1 is a perspective view of an embodiment of the present invention.

FIG. 2 is a perspective view of another embodiment of an electronic image display system according to the present invention.

FIG. 3 is a perspective view of a support structure according to the embodiment of the invention shown in FIGS. 1 and 2.

FIG. 4 is a diagram of the interior of a backpack of the embodiment of FIG. 1.

FIG. 5 is a perspective view of another embodiment of the present invention.

FIG. 6 is a diagram of the interior of a backpack of the embodiment of the present invention shown in FIG. 5.

### DETAILED DESCRIPTION OF THE PREFERRED EMBODIMENT

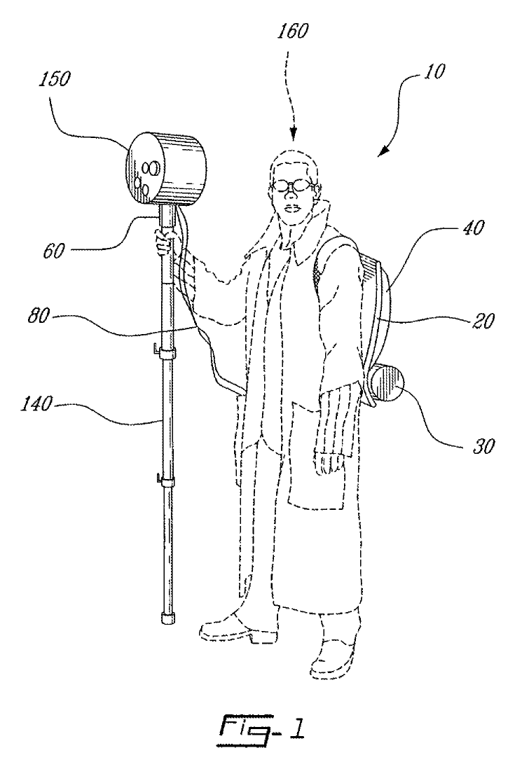

In one aspect, as shown in FIG. 1, the present invention relates to an electronic image display system 10. The electronic image display system 10 comprises a projector 150, a general support frame 20, on which is mounted a base support means 30, and a carrying sack 40. The projector 150 may be mounted on a telescoping pole 140 such that an operator 160 can carry the projector 150 or support the projector 150 on the ground via the telescoping pole 140. At the upper end of telescoping pole 140 is mounted connecting means 60 which is used to attach the projector 150 to the telescoping pole 140. The connecting means 60, comprising pivotal connector, allow the human operator 160 to change the direction of the projection, by changing the orientation and the direction of the projector 150.

The carrying sack 40, mounted to the support frame 20, contains a video signal generating means (see below) which is connected to the projector 150 by cable means 80 and which allows for the video signal generating means to send video signals to the projector 150 which can then project the corresponding image or presentation.

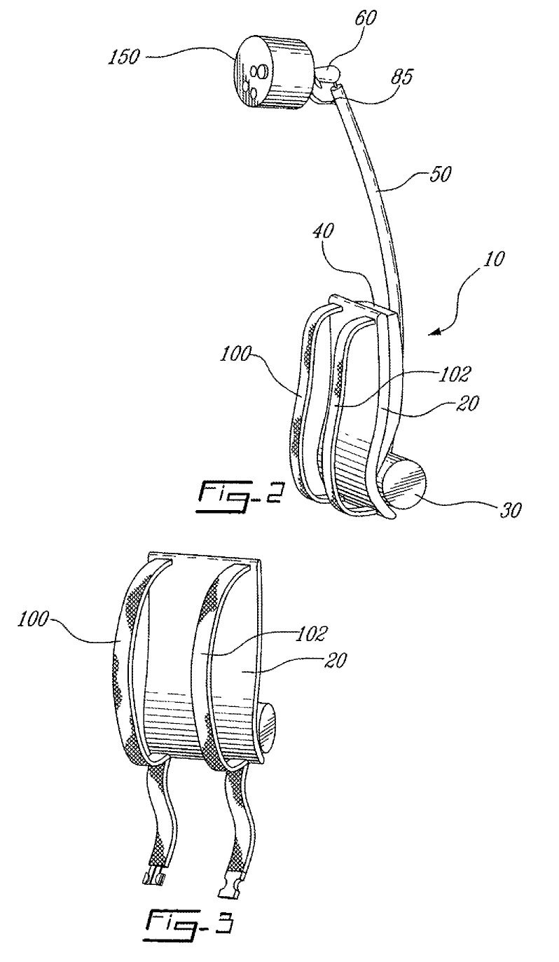

FIGS. 2 and 7 show the electronic image display system 10 in another embodiment comprising a projector 150, a general support frame 20, on which is mounted a base support means 30, and a carrying sack 40. An elongated member 50, preferably but not exclusively in the form of a hollow tube or other similar element is attached at one end to the base support means 30. At the other end of the hollow tube 50 are mounted connecting means 60 which are used to attach display device 150 to the hollow tube 50 at any orientation chosen by the human operator. As in the embodiment of FIG. 1, the connecting means 60, comprising pivotal connector, allow the human operator 160 to change the direction of the projection, by changing the orientation and the direction of the projector 150. Also as in the first embodiment, the carrying sack 40 contains a video signal generating means which is connected to the projector 150 by cable means 85, which allows the video signal generating means to send video signals to the projector 150 which can then project the corresponding image on any appropriate surface.

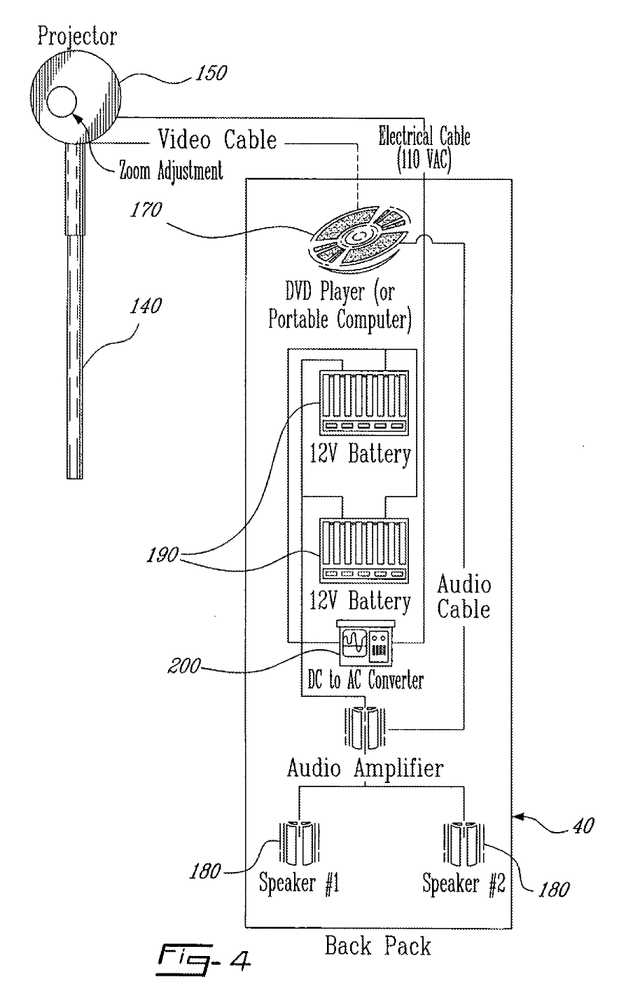

As can be seen in FIG. 3, the general support frame 20, comprises two straps 100 and 102 which can be used to fasten the general support frame 20 to the body of an operator. Furthermore, the general support frame 20 may have a curvature adapted to fit to the natural curvature of a person body. This allows for greater comfort while carrying the system.

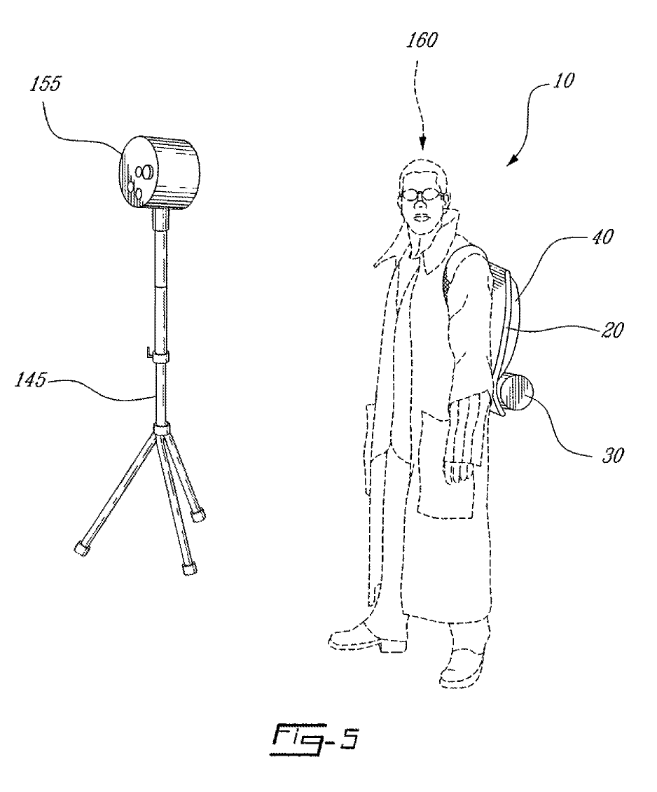

FIG. 4 shows a diagram of the contents of the backpack 40 where a projector 150 is used. In this embodiment, the backpack 40 preferably contains a video signal generating means 170, such as a DVD or other media player or a portable computer. The video signal generating means 170 generates an image based on a video program stored on a storage means, for instance a DVD disk or a video file. Still referring to FIG. 4, the backpack 40 may also contain batteries 190, speakers 180 and AC/DC converter 200. The backpack 40 is preferably made from a hard plastic shell. The video signal generating means 170 is connected to the projector 150 such that the image generated by the video signal generating means 170 is projected by the projector 150.

Additionally, the video signal generating means 170 is connected to a pair of speakers 180 such that an audio component generated by said video signal generating means 170 can be played back on speakers 180. The speakers 180 may also be placed on either end of the base support means 30. Other locations are also possible and within the scope of the invention.

As mentioned above, the backpack 40 preferably contains a pair of batteries 190 which power the projector 150 and the speakers 180. Depending on the type of device used, the video signal generating means 170 may have a separate power source or may be connected to the batteries 190. The backpack 40 may also include a DC to AC converter 200 if an AC driven projector is used. The skilled addressee will understand that the backpack 40 may also contain all other components which could be required by the electronic image display system.

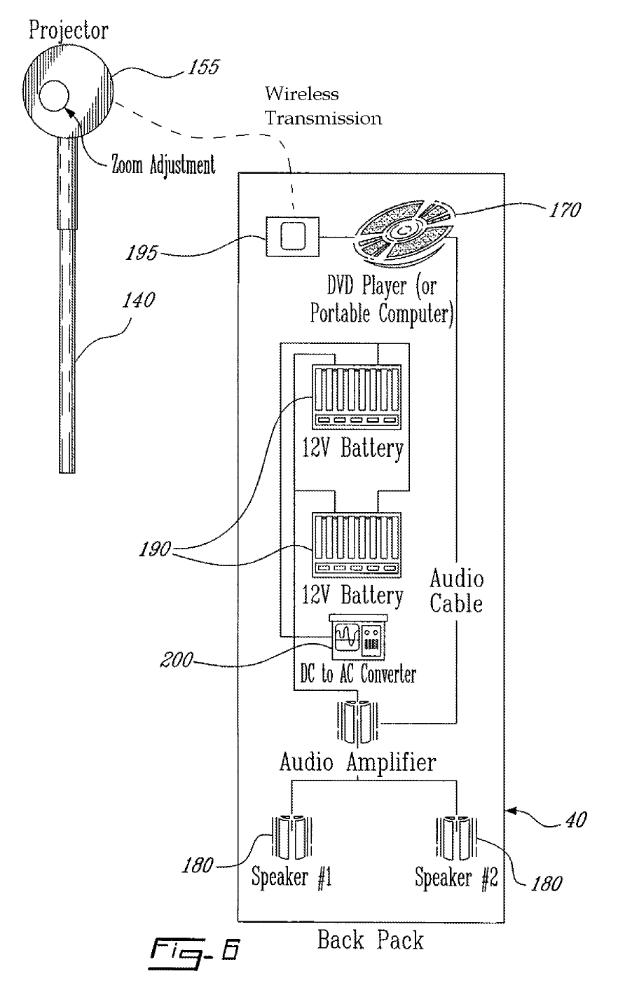

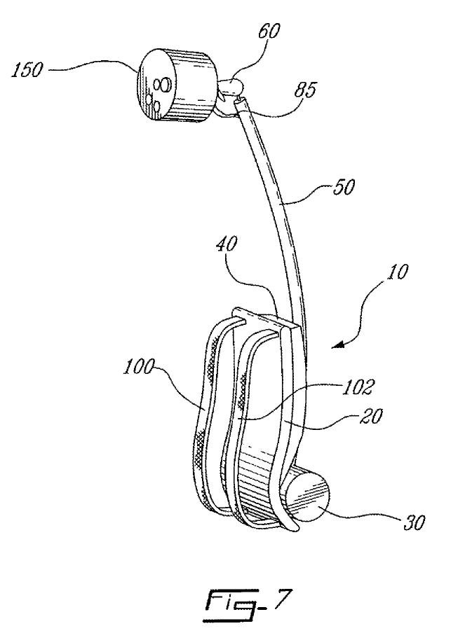

In FIG. 5, another embodiment of the present invention is shown where the projector 155 is wireless and can receive a wireless video signal. In this embodiment, the projector 155 can be mounted on a tripod 145, or other mechanically equivalent stand-alone structures, which can stand alone and at different height. In this embodiment, the operator 160 can move near and around the projector 155 since the video signal is sent by a wireless transmitter (shown in FIG. 6). As in the two previous embodiments, the projector 155 is preferably mounted to the tripod 145 with connecting means 60 comprising pivotal connector, which allows the operator to adjust the direction of the projection.

FIG. 6 shows a diagram of the contents of the backpack 40 where a wireless projector 155 is used. In this embodiment, the data is processed by the video signal generating means 170 and transferred to a wireless transceiver 195 which will then send the video signal to the wireless projector 155. The power source for the wireless projector 155 is preferably a battery located inside the projector (not shown). Alternatively, the wireless projector could be powered by means of an electrical cable (not shown) to be connected to an external power source or to the batteries of the backpack 40.

The skilled addressee will understand that the wireless transmission between the transceiver 195 and the wireless projector 155 can be effected via any appropriate wireless transmission protocol such as, but not limited to, Wi-Fi (IEEE 802.11), as long as the wireless protocol provides enough bandwidth for transmitting the required video signals.

Although preferred embodiments of the invention have been described in detail herein and illustrated in the accompanying figures, it is to be understood that the invention is not limited to these precise embodiments and that various changes and modifications may be effected therein without departing from the scope or spirit of the present invention.

1. An electronic image display system comprising:
a. a projector for projecting a video image on a surface external to said projector, said projector comprising video signals input means and means to connect said projector to an electrical power source;
b. a support structure having means to attach said support structure to the human body of an operator, said support structure comprising a video signal generating means, having a video signals output means, and a storage device, readable by said video signal generating means, for storing at least one video file;
c. communication means linking said projector and said video signal generating means for transmission of said video signals between said video signal generating means and said projector.

2. An electronic image display system as described in claim 1, wherein said communication means include wireless transceivers to connect said projector to said video signal generating means.

3. An electronic image display system as described in claim 2, wherein said wireless projector is used to project said video image.

4. An electronic image display system as described in claim 3, wherein said wireless projector includes an internal battery.

5. An electronic image display system as described in claim 3, wherein said wireless projector is connected to an external power source with cable means.

6. An electronic image display system as described in claim 1, wherein communication means include cable means to connect said projector to said video signal generating means.

7. An electronic image display system as described in claim 1, wherein said projector comprises a projector support.

8. An electronic image display system as described in claim 7, wherein said support structure comprises an elongated member extending upwardly at least above the shoulders of said human body and wherein said projector is attached to said elongated member via said projector support.

9. An electronic image display system as described in claim 8, wherein said elongated member is attached to said projector support via a pivotal connector whereby the orientation of said projector is adjustable.

10. An electronic image display system as described in claim 7, further comprising a telescopic pole and wherein said projector is mounted to said telescopic pole via said projector support.

11. An electronic image display system as described in claim 10, wherein said telescopic pole is attached to said projector support via a pivotal connector whereby the orientation of said projector is adjustable.

12. An electronic image display system as described in claim 7, further comprising a tripod and wherein said projector is mounted to said tripod via said projector support.

13. An electronic image display system as described in claim 12, wherein said projector support is attached to said tripod via a pivotal connector whereby the orientation of said projector is adjustable.

14. An electronic image display system as described in claim 7, wherein a carrying sack is mounted on said support structure.

15. An electronic image display system as described in claim 14, wherein said video signal generating means and said storage device are located inside said carrying sack.

16. An electronic image display system as described in claim 15, wherein said portable display system further comprises at least one speaker connected to said video signal generating means.

17. An electronic image display system as described in claim 16, wherein said at least one speaker is attached to said support structure.

18. An electronic image display system as described in claim 17, wherein said carrying sack further comprises a power supply.

19. An electronic image display system as described in claim 18, wherein said power supply includes at least one battery.

20. An electronic image display system as described in claim 19, wherein said carrying sack further comprising a DC to AC electrical converter connected to said power supply.

21. An electronic image display system as described in claim 18, wherein said video signal generating means further comprises an audio signal output.

22. An electronic image display system as described in claim 21, wherein said video signal generating means is a Digital Versatile Disk (DVD) player.

23. An electronic image display system as described in claim 21, wherein said video signal generating means is a portable computer.

24. An electronic image display system as described in claim 23, wherein said support structure further comprises straps to mount said support structure to said human body.
